(19) United States
(12) Patent Application Publication
(10) Pub. No.: US 2022/0101743 A1
(43) Pub. Date: Mar. 31, 2022

(54) Studio Arrangement and Playing Devices Whereby Online Students Worldwide Can Learn Mathematics from an Outstanding Teacher by Watching Videos Showing the Teachers Face Body Language and Clearly Legible Writing

(71) Applicant: Mark Laurence Donald Emerson, Austin, TX (US)

(72) Inventor: Mark Laurence Donald Emerson, Austin, TX (US)

(21) Appl. No.: 17/484,216

(22) Filed: Sep. 24, 2021

Related U.S. Application Data
(60) Provisional application No. 63/083,394, filed on Sep. 25, 2020.

(51) Int. Cl. G09B 5/06; G09B 5/12; H04L 29/06; G09B 7/00

(52) U.S. Cl. CPC G09B 5/065; G09B 7/00; H04L 65/4015; G09B 5/12

(57) ABSTRACT

A studio arrangement and plurality of playing devices, wherein an outstanding teacher of mathematics or a math-oriented subject can produce a video of a lesson, which video captures the teacher's face, hands and full body language, while also capturing, clearly and legibly, what he or she writes during the lesson. The video is then transmitted via the Internet to online students worldwide, who view the video on their playing devices, such as computers and smart phones, and thereby learn from the outstanding teacher.

### CROSS-REFERENCE TO PROVISIONAL PATENT APPLICATION

This nonprovisional patent application is made in reference to the provisional patent application with the title, “Method for Capturing on Video the Holistic Presentation of Lessons in Mathematics and Math-Related Subjects,” by the same inventor and filed on 25 Sep. 2020 at 15:05:04 Eastern Time, Application No. 63/083,394, EFS ID 40672913, Confirmation Number 9491.

### NOTICE RE INCLUSIVITY

The invention described herein concerns teachers and students who can see and hear. Uses of the words “teacher” and “student” presume reasonably good vision and hearing, perhaps aided by eyeglasses or hearing aids. Another invention will be needed for people with severe vision or hearing impairment.

### BACKGROUND OF THE INVENTION

Outstanding teachers use a variety of means to communicate with and impart knowledge to their students. Pertinent here is the teaching of mathematics, such as algebra, and math-related subjects, such as physics, where precise mathematical expressions are involved, such as equations. When outstanding teachers teach such subjects, they utilize most or all of the following means of communication in their presentations to their students:
1. The teacher speaks to the students, varying his or her tone of voice while speaking, and the students hear this;
2. The teacher writes expressions that the students see and read;
3. The teacher erases or crosses out or underlines or circles or otherwise emphasizes, highlights or modifies things already written, and the students see this;
4. The teacher makes hand and arm gestures (other than writing) that the students see, including waving their hands in the air to illustrate a concept, and including pointing at things already written;
5. The teacher makes facial expressions, makes eye contact with students, and generally presents body language that the students see; and
6. In response to the teacher doing all of the above, students present body language, ask questions and make comments, which the teacher sees and hears, and to which the teacher responds.

All of the foregoing means of communication happen in real time, in synchrony with each other, and, with respect to the students' learning, the whole is greater than the sum of the parts. When the first five of the foregoing means of communication (items 1-5) are effectively utilized in the teacher's presentation, it shall be referred to herein as a “Static Holistic Presentation” (“static” because items 1-5 involve no input from any student to the teacher and hence the entire presentation can be “statically” known to the teacher in advance). When, in addition, the last of the foregoing means of communication (item 6) is effectively utilized in the teacher's presentation, it shall be referred to herein as a “Dynamic Holistic Presentation” (“dynamic” because the presentation can be altered by input from students, which input cannot be known to the teacher in advance). The term “Holistic Presentation” shall refer to a presentation that is a Static or Dynamic Holistic Presentation.

For the benefit of students who are not physically present with such an outstanding teacher, there exists a need to capture his or her Holistic Presentations on videos that can be viewed remotely or at a later time (including after the teacher's death). However, recording a Holistic Presentation on video is difficult. In particular, it is difficult to capture legibly the writing the teacher does while also capturing the entirety of the teacher's body language. Recording a Dynamic Holistic Presentation on video is even more difficult, because, in addition, it must capture one or more students and their body language. Consequently, as a search of math teaching videos on the Internet will confirm, Holistic Presentations are rare in the online world (if any exist at all).

A Holistic Presentation can be given live in a classroom filled with seated students, where the teacher writes on a vertical medium that students view from their seats. Vertical media include the “white board” written on with “dry erase” markers, the old fashioned “black board” written on with chalk, or even a large paper fastened vertically to a wall or easel and written on with thick ink markers. These methods require larger writing than the writing one does on paper. When writing with chalk or a dry-erase marker, much (or all) of the writing is done mainly by arm movement, rather than finger movement, whereas writing on paper with a pen or pencil is done mainly by finger movement.

Another classroom approach is for the teacher to write small writing (i.e., mainly with fingers and not much arm motion) onto a table-top or podium-top device that causes the writing to be projected onto a large vertical format. One way to do this is writing horizontally on a “viewgraph slide” that is being projected onto a vertical screen. A more modern way is to use a computerized device, writing with a keyboard, mouse or stylus, with the result displayed digitally, either through a projector onto a vertical screen, or directly onto a large, vertically mounted digital display. However, these “small writing” methods significantly handicap a Holistic Presentation in four ways. First, students cannot see the teacher's hand and arm writing on the vertical medium. Second, there is necessarily a physical distance between the small writing device and the large vertical display, and this decreases the impact and effectiveness of teacher's gestures and body language in connection with what is being written. Third, teachers who use such devices tend to cling to the device, often sitting on a stool, rather than standing before the vertical medium, pointing and gesturing as they speak. Fourth, writing on such devices is not as natural as writing on paper or on a vertical board, and the quality of the handwriting tends to suffer.

A Holistic Presentation can also be given to one or a small number of students who are seated at a table with the teacher. In this format, the teacher can simply write on a paper that is resting horizontally on the table using a pencil or pen. When teaching mathematics on paper, pencil is generally preferred because it is easy to erase.

Regardless of whether the display medium is horizontal or vertical, and regardless of whether or not digital technology is used to display the teacher's writing, it remains difficult to capture a Holistic Presentation on video.

Video capture of white-board writing is problematic for two reasons. The first is the lighting. White boards are shiny and reflective, and the quality of the video image varies with the angles between the camera, the writing and the light sources, and this means the image quality of the writing varies greatly from one area on the board to another. The second is the markers. Dry-erase markers do not apply a marking of consistent darkness—darkness varies with the pressure applied, the angle at which the marker is held, the age of the marker, the speed of writing (faster writing requires a faster ink flow) and perhaps other factors. These lighting and marking fluctuations are tolerable when viewed directly, but they are exacerbated on video. Pointing a video camera at a white board as a teacher writes with dry-erase markers tends to result in a poor video image of the writing that is difficult and a strain for viewers of the video to read. Old-fashioned chalk on a blackboard is no better and for similar reasons. Screen projections are likewise difficult to legibly capture by pointing a video camera at the projection screen. Although writing on a computerized device can be captured digitally without using a video camera (software can be used to generate video directly from the digitally stored writing), as indicated above, such writing is less natural than writing directly on a vertical board or on paper. Pencil or small pen writing on paper comes out poorly on video because the line widths are thin, and pixilation tends to make them come out grayish on video, and hence harder to read. Moreover, pencil is invariably gray in color, rather than black, even in the softest 9B or 12B degree, and hence has less contrast with the white paper than true black, which reduces the sharpness of the video.

### BRIEF SUMMARY OF THE INVENTION

The invention provides a simple and effective means by which an outstanding teacher records a Holistic Presentation of a mathematical lesson (“Lesson”) on a digital video that shows the teacher's entire upper body language and also shows the teacher's writing with crisp, fully legible sharpness. The video is then digitally transmitted via the Internet to desktop computers, laptop computers, tablet computers and smart phones worldwide, on which students worldwide view the Holistic Presentation and learn online from the outstanding teacher.

A first embodiment of the invention (“First Embodiment”) records a Static Holistic Presentation in a small video studio (the “Studio”) wherein the teacher (the “Teacher”) sits at a table (the “Table”) and writes on paper. A second embodiment of the invention (“Second Embodiment”) records a Dynamic Holistic Presentation that additionally includes a student in the studio (the “Studio Student”), who sits next to the Teacher, and who also writes on paper. Either way, other students who will view the Holistic Presentation online are called “Online Students.” The discussion hereinbelow generally presumes the presence of the Studio Student, but in the case of the First Embodiment of the invention, the Studio Student is absent.

The Studio includes two video cameras, both of which produce raw digital videos of the Lesson from their respective viewpoints. One camera is mounted on a tripod that rests on the studio floor and faces front (the “Front Camera”)—it captures the facial expressions and body language of the Teacher and the Studio Student. The other camera is mounted on the ceiling and faces downward onto the papers (the “Top Camera”)—it captures everything that is written on the papers, as well as the Teacher's and the Studio Student's hand motions relative to the papers, including pointing at things already written. There is a backdrop behind them. The Table is slightly rotated relative to the backdrop so that right-handed writing by the Teacher looks more natural (the Table should be rotated the other way, and the seats interchanged, if the teacher is left-handed). Pencil is not used because it is too gray. Small pens are not used because their lines are too thin (typically about 0.5 millimeters). Instead, writing is done with permanent markers that deliver solid, uniform black (or other desired color) with a thickness of about 1.5 millimeters (an “Intense Pen”), such as the commercially available “Sharpie Fine Point.” Experimentation has shown that a properly adjusted Top Camera (such as the commercially available “Handycam” by Sony) captures a sharp, easy-to-read image of such writing. Most video cameras today include microphones that are mounted within the camera. However, such camera-mounted microphones are of marginal quality, and are not well positioned in this setup. Therefore, a separate audio recording device (“Audio Recorder”) is used with a pair of high-quality lavalier microphones (each a “Mic”)—one worn by the Teacher, the other by the Studio Student—that are wired to the Audio Recorder, which produces a raw digital audio of the Lesson. Several “soft box” lights are used to light their faces, the papers and the backdrop.

To make use of the invention, the Teacher prepares Lesson materials in advance, including the papers needed. In the First Embodiment, the Teacher then sits at the Table, the lights, cameras and audio are activated and the Teacher teaches the Lesson to the (future) Online Students, sometimes addressing them by looking directly into the Front Camera, and other times talking to them while looking down to as he or she writes on or points to papers on the table. In the Second Embodiment, the Teacher and the Studio Student sit together at the Table, the lights, cameras and audio are activated and the Teacher teaches the Lesson to the Studio Student, only occasionally addressing the Online Students by looking directly into the Front Camera. Either way, when the Lesson is finished, the cameras and audio are switched off.

The raw videos are then extracted from the two cameras, and the raw audio is extracted from the Audio Recorder, and they are input into a video editor (the “Video Editor”), which is then used to create the video of the Holistic Presentation (the “Educational Video”), which integrates images from both cameras and beautifully captures the Holistic Presentation. The finished Educational Video is transmitted to the Internet, and then downloaded and viewed by Online Students on their computers, tablets or smart phones (each hereinafter called a “Player”) that play the video.

Alternatively, the Lesson can be livestreamed to the Online Students, in which case the Video Editor is replaced with a livestream control and switching device (“Switcher”) that integrates in real time the signals from the Front Camera, Top Camera and Mic (or Mics if a Studio Student is present), and outputs the Educational Video as a livestream video to the Internet, which the Online Students view in real time on their Players. In this configuration the Audio Recorder is replaced by an “Audio System,” consisting of the Mic or Mics and perhaps a pre-amplifier or other livestream audio processor.

### BRIEF DESCRIPTION OF THE DRAWINGS

FIG. 1 shows a plan view of the Studio, including the Table, the Teacher and Studio Student in their chairs, the Front Camera the Top Camera the Audio Recorder, papers on the Table, three soft-box lights, the backdrop and other details described below.

FIG. 2 shows a side elevation of the Studio, including the Table, the two chairs, the Front Camera and its tripod, the Top Camera and its ceiling mount, the Audio Recorder, the backdrop and other details described below. (The Teacher, Studio Student and lights are omitted).

FIG. 3 shows a closer view of a portion of the elevation in FIG. 2, with the Teacher and Studio Student included. (The Audio Recorder and lights are omitted).

FIG. 4 shows a front elevation of the Studio from the top of the Table to the ceiling, including the Teacher, the Studio Student, the Top Camera and its ceiling mount, the backdrop and other details described below. (The Front Camera, Audio Recorder and lights are omitted).

FIG. 5 shows an image captured by the Front Camera of the Teacher and Studio Student.

FIG. 6 shows an image captured by the Top Camera, including a paper that the Teacher is writing on, the Teacher's arm and hand, and the Intense Pen with which he or she is writing.

FIG. 7 shows an image produced by the Video Editor wherein the image captured by the Top Camera shown in FIG. 6 fills the whole screen, with a smaller-sized image captured by the Front Camera shown in FIG. 5 inset at the top right.

FIG. 8 shows an image produced by the Video Editor, in which the Studio Student is writing on another paper, wherein the image captured by the Top Camera fills the whole screen, with a smaller-sized image captured by the Front Camera inset at the bottom left.

FIG. 9 shows the same view as FIG. 1, but with the Studio Student not present, the Teacher sitting in the center and the Top Camera omitted to avoid obscuring the Teacher's hand.

FIG. 10 shows the same view as FIG. 2, but with the Studio Student's chair not present.

FIG. 11 shows the same view as FIG. 3, but with the Studio Student not present.

FIG. 12 shows the same view as FIG. 4, but with the Studio Student not present and the Teacher sitting in the center.

FIG. 13 shows an image captured by the Front Camera of the Teacher similar to that in FIG. 5, but with the Studio Student not present and the Teacher sitting in the center.

FIG. 14 shows an image produced by the Video Editor similar to that shown in FIG. 7, but with the Studio Student not present and the Teacher sitting in the center of the inset. The image captured by the Top Camera shown in FIG. 6 fills the whole screen, with a smaller-sized image captured by the Front Camera shown in FIG. 13 inset at the top right.

FIG. 15 shows an image produced by the Video Editor in which images from the two cameras are shown side-by-side—a cropped portion of the Top Camera image in FIG. 6 is on the left, and a cropped portion of the Front Camera image in FIG. 13 is on the right.

FIG. 16 shows a functional diagram of the Front Camera, Top Camera, Audio Recorder and Video Editor, all within the Studio, the transfer of raw video and raw audio into the editor, and its output of the finished Educational Video.

FIG. 17 shows a functional diagram of the Studio, as a whole, three of the Players, and the transmission of the Educational Video via the Internet from the Studio to the Players.

FIG. 18 shows an Online Student viewing the video of the Holistic Presentation on a Player.

FIG. 19 shows a functional diagram of the Front Camera, Top Camera, Audio System and Switcher, all within the Studio, the transfer of video and audio signals into the Switcher, and its livestream output of the Educational Video to the Internet.

### DETAILED DESCRIPTION OF THE EMBODIMENTS OF THE INVENTION

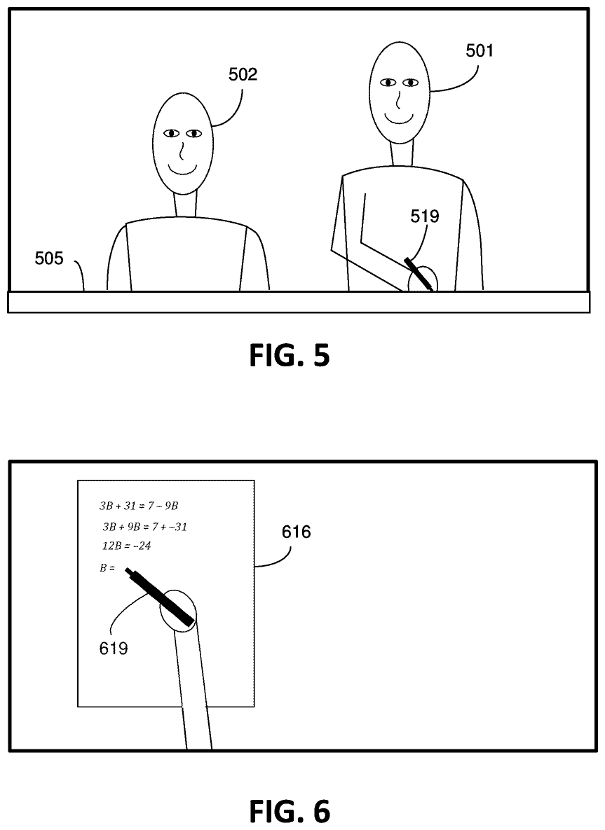

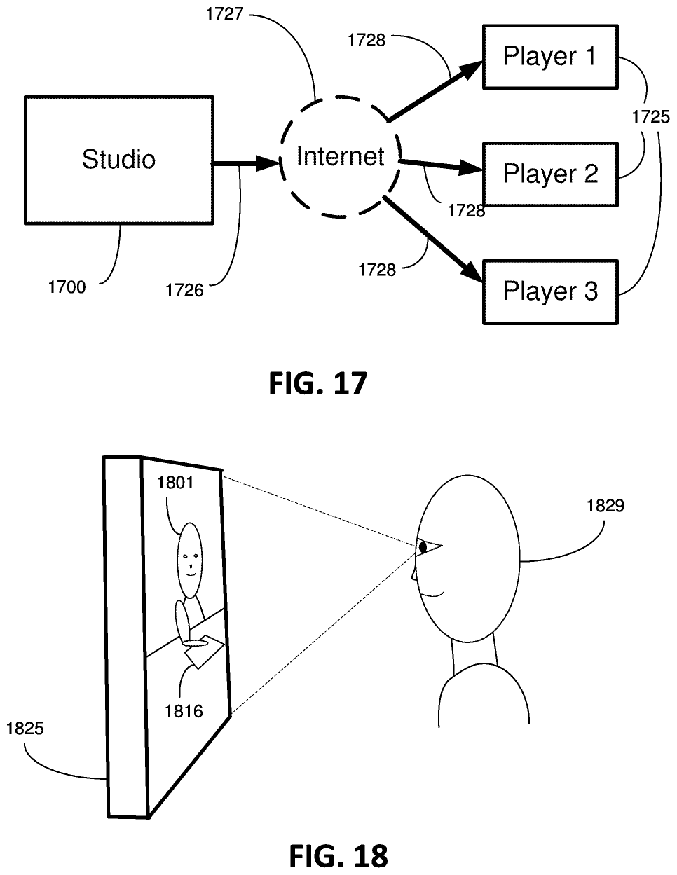

The invention captures a Holistic Presentation of a mathematical Lesson by the Teacher in the form of an Educational Video. As shown in FIG. 17, the Educational Video is produced in the Studio, 1700, digitally uploaded, 1726, onto one or more servers within the Internet, 1727, and then downloaded, 1728, to various Players, 1725, which are desktop computers, laptop computers, tablet computers and smart phones. As shown in FIG. 18, an Online Student, 1829, then views the Educational Video on his or her Player, 1825, whereby he or she sees a digital image of the Teacher, 1801, teaching the Lesson, including writing on paper, 1816. While viewing the Educational Video, the Online Student will see images like those depicted in FIGS. 6, 13, 14 and 15 (in the First Embodiment) or those depicted in FIGS. 5, 6, 7 and 8 (in the Second Embodiment).

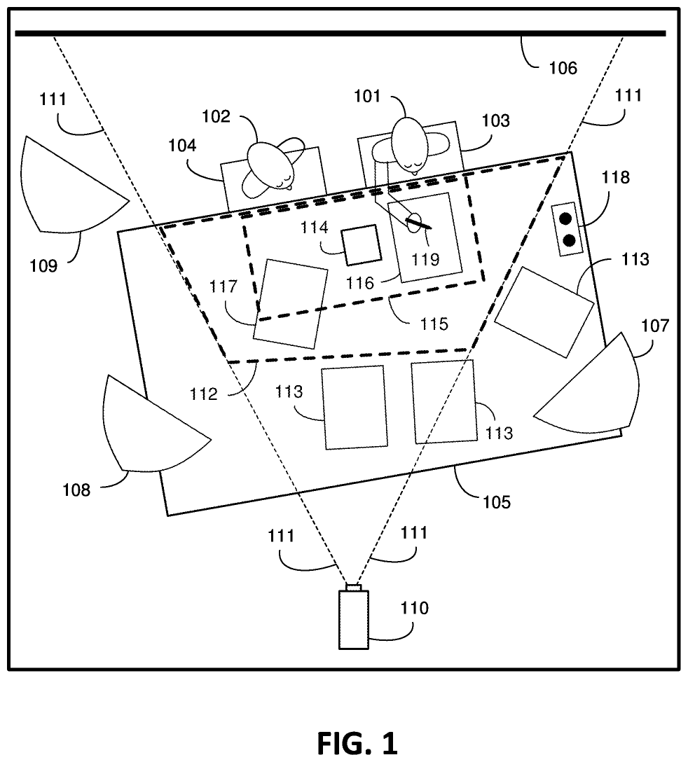

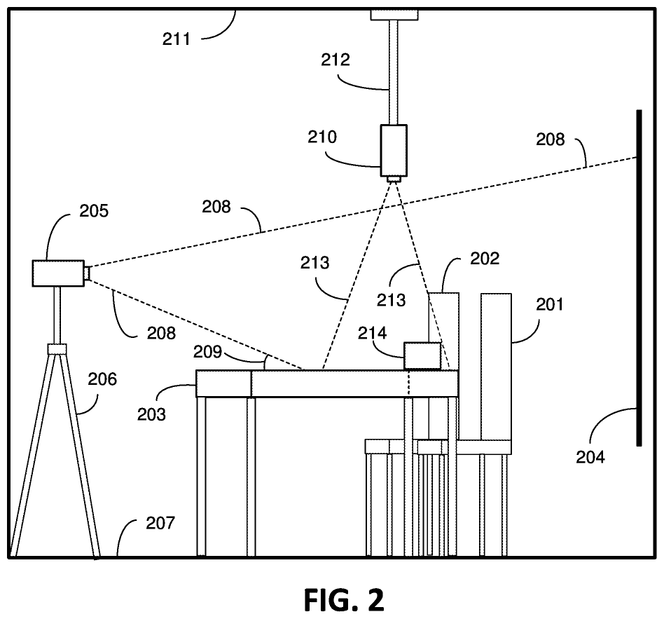

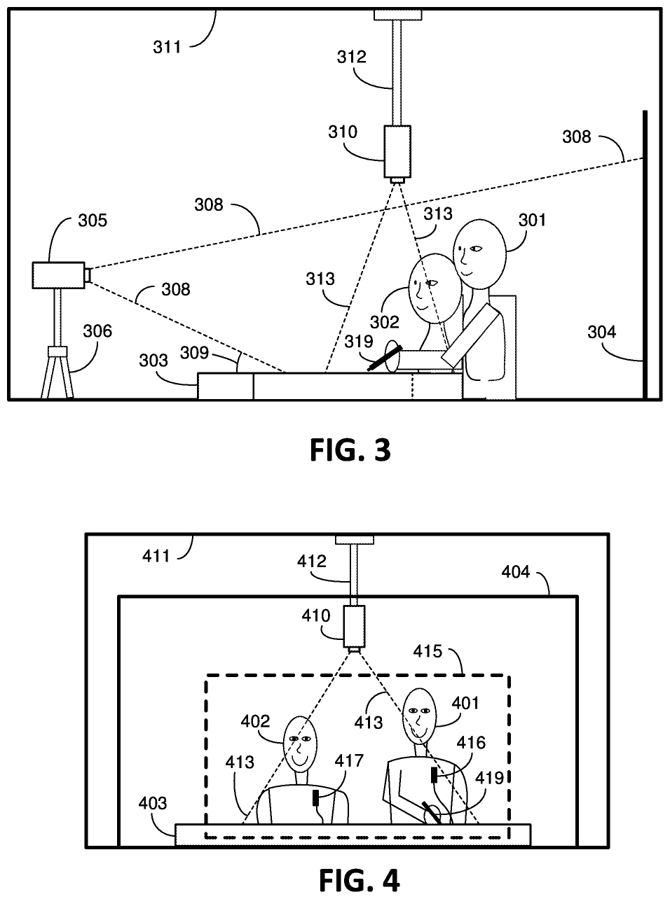

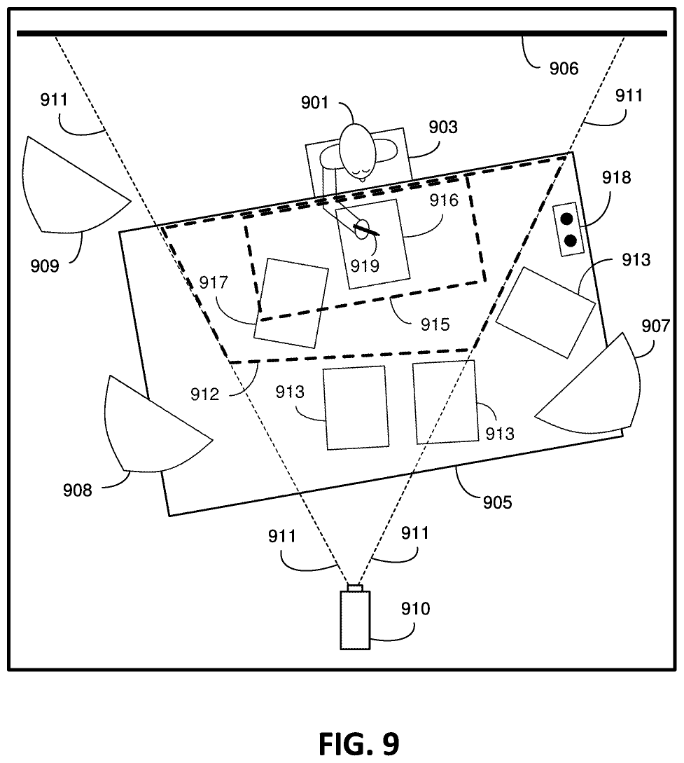

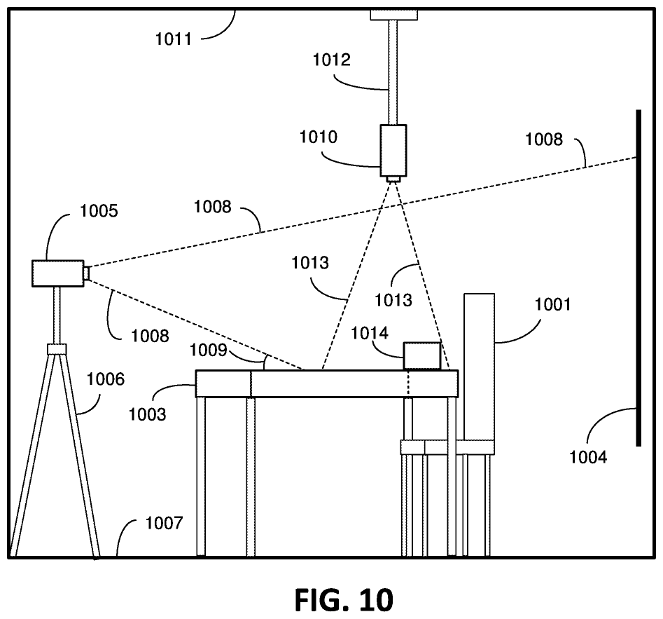

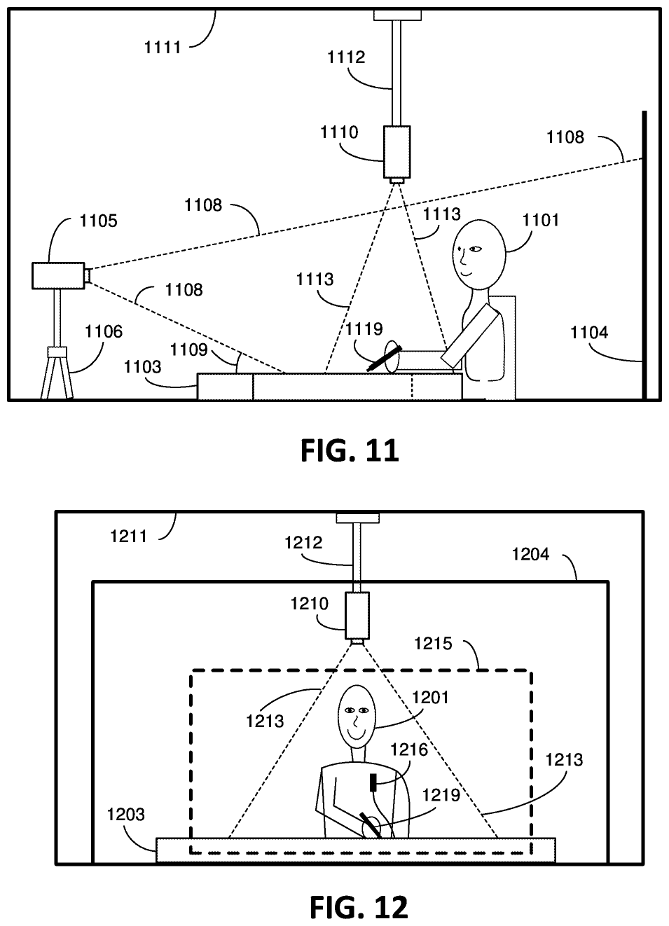

Most of the ensuing discussion concerns what happens inside the Studio to create the Educational Video. The Studio is physically depicted in FIGS. 1-4 and 9-12. Therein, the Teacher, 101, 301, 401, 501, 901, 1101, 1201, 1301, records the Lesson. In the First Embodiment, the Studio setup is shown in FIGS. 9-12, and the Teacher addresses the Online Students directly, often speaking while looking directly into the Front Camera, 910, 1005, 1105. In the Second Embodiment, shown in FIGS. 1-4, the Teacher teaches the Studio Student, 102, 302, 402, 502, making frequent eye contact with him or her, and less often facing the Front Camera, 110, 205, 305.

In the First Embodiment, the Teacher sits alone in a chair, 903, 1001, at the Table, 905, 1003, 1103, 1203, 1305, with a backdrop, 906, 1004, 1104 and 1204, behind him or her, and soft-box lights, 907, 908, 909, illuminate the Teacher, backdrop and Table top. In the Second Embodiment, the Teacher and the Studio Student sit in chairs, 103, 104, 201, 202, at the Table, 105, 203, 303, 403, 505, with a backdrop, 106, 204, 304, 404, behind them, and soft-box lights, 107, 108, 109, illuminate the Teacher, Studio Student, backdrop and Table top. In both embodiments, the Table is rotated somewhat so that right-handed writing by the Teacher appears more natural. Alternatively (and not shown in the Figs.) the Teacher can stand behind the Table in the first embodiment, and, in the second embodiment, the Teacher and Student can stand behind the Table—in either case, the Table can be raised to a higher level to accommodate writing while standing.

In both embodiments, the Front Camera, 110, 205, 305, 910, 1005, 1105, 1602, is mounted on a tripod, 206, 306, 1006, 1106, that rests on the floor, 207, 1007, of the Studio. It is aimed at the Teacher and, in the Second Embodiment, the Studio Student, focused on their faces, and adjusted so that the spread of its field of view diverges from its lens as depicted by dotted lines, 111, 208, 308, 911, 1008, 1108. In FIGS. 1 and 9, the boldfaced dotted, non-rectangular quadrilateral, 112, 912 (the “Front Quadrilateral”), one of whose sides runs along the edge of the Table next to the Teacher, shows where its field of view intersects the top of the Table. In FIGS. 4 and 12, the boldfaced dotted rectangle, 415, 1215, shows the Front Camera's field of view. Papers and other items resting on the Table that are within the Front Quadrilateral are visible to the Front Camera, and items on the Table outside thereof are not. The three sides of Front Quadrilateral, other than the side along the Table edge, are marked with tape on the Table top, which tape is just outside the view of the Front Camera, so that the Teacher (and, in the Second Embodiment, the Studio Student) can see the boundary. Hence, prepared papers and blank papers to be used in the presentation, 113, 913, may be stored out of view and, at the appropriate time, the Teacher can reach for them and bring them into view. However, although papers resting within the Front Quadrilateral are visible to the Front Camera, they are not readable from the Front Camera because of its oblique angle, 209, 309, 1009, 1109.

In both embodiments, the Top Camera, 114, 210, 310, 410, 1010, 1110, 1210, 1603, is attached to the Studio ceiling, 211, 311, 411, 1011, 1111, 1211, by a mounting device, 212, 312, 412, 1012, 1112, 1212. It is aimed at the Table, focused on the plane of the Table top for sharp viewing of the writing on papers, and adjusted so that the spread of its field of view diverges from its lens as depicted as the dotted lines, 213, 313, 413, 1013, 1113, 1213. In FIGS. 1 and 9, the boldfaced dotted rectangle, 115, 915 (the “Top Rectangle”), shows where its field of view intersects the top of the Table. The entirety of the Top Rectangle necessarily lies within the Front Quadrilateral. Papers and other items resting on the Table that are within the Top Rectangle, such as the paper, 116, 616, 716, 916, on which the Teacher is writing, are visible to the Top Camera, and items on the Table outside thereof are not. A paper, 117, 917, that lays across the boundary of the Top Rectangle but inside the Front Quadrilateral, is fully visible to (but not readable from) the Front Camera and partially visible to (and readable from) the Top Camera. The four sides of the Top Rectangle are marked (e.g., with tape) on the Table so that the Teacher (and, in the Second Embodiment, the Studio Student) can see the boundary, but such marking should be narrow, and in a color not too different than that of the Table top, because it is visible (at an oblique angle) to the Front Camera. Experimentation has shown that this marking does not cause a distraction in the Front Camera image, and might even enhance the presentation because observant Online Students can see that the papers they see in the Front Camera image that are within the mildly visible marking of the Top Rectangle are the same papers they see in the Top Camera image.

In the First Embodiment, the Audio Recorder, 918, 1014, is wired to the Teacher's Mic, 1216. In the Second Embodiment, Audio Recorder, 118, 214, is wired to the Teacher's Mic, 416, and to the Studio Student's Mic, 417, and it records separate, synchronized audio channels for the two respective Mics. Alternatively, the Mic or Mics might have a wireless connection to the Audio Recorder.

In both embodiments, the Teacher writes on paper as depicted in FIGS. 6, 7 and 14, and in the Second Embodiment, the Studio Student writes on a paper as depicted in FIG. 8. The writing is done with an Intense Pen, 119, 319, 419, 519, 619, 919, 1119, 1219, 1319 that delivers a solid, uniform marking in black or other desired color, with a thickness of about 1.5 millimeters. The writing should be done so that letters and numbers have a height of approximately 7-10 millimeters to ensure that the Top Camera captures a clear, readable image of the writing. Stated another way, the size of the writing should be proportionate with the 1.5 millimeters thickness of the line produced by the Intense Pen. When lined paper is used, the line spacing should be approximately 12 millimeters, which is wider than most commercially available lined paper. Experimentation produced the best results with custom-printed lined paper with 12 millimeters spacing. Similarly, when graph paper is used, the gridline spacing should be approximately 8 millimeters, which is wider than most commercially available graph paper. Again, experimentation produced the best results with custom-printed graph paper with 8 millimeters spacing. Prior to creating any video, the Teacher (and the Studio Student if present) should practice and get accustomed to using an Intense Pen to write words and numbers approximately 7-10 millimeters high, including on 12-millimeter-spaced lined paper.

In the Second Embodiment, at the time a Lesson is recorded in the Studio, the Lesson should be on matters that the Studio Student is academically ready for, but has not yet learned. That way, the Studio Student's responses to the Teacher will be innocent and genuine. Online Students who later view the lesson will notice this—they will learn both from the Teacher teaching and from seeing the Studio Student learning.

Before the Lesson is recorded, the Teacher prepares all the lesson papers. If lesson papers are prepared on a computer and printed using a printer, large fonts should be used, typically 18 point or higher so it can be clearly captured by the Top Camera and read by the Online Students. If the lesson papers contain a diagram that is printed or drawn, the line thickness and details of the diagram should be large enough that, in the Educational Video, the diagram can be clearly read by the Online Students. Use of different colors of papers for different functional purposes can enhance the presentation, especially for pre-printed papers. For example: blue paper for the main points or agenda of the Lesson; pink paper for rules being taught; yellow paper for problems; green paper for answers thereto; while white paper (blank, lined and graph) is used for writing done during the Lesson. The papers to be used at the beginning of the Lesson may be placed within the Top Rectangle, while other papers to be used later in the lesson may be placed within the Teacher's reach but outside the Front Quadrilateral. The Teacher should rehearse the Lesson in advance, including what he or she will write.

When it is time to record the Lesson, the Teacher puts on his or her Mic, 416, 1216, and in the Second Embodiment, the Studio Student puts on his or her Mic, 417. When ready to start, both cameras and the Audio Recorder are activated to record mode. The Teacher (or Studio Student) then does a hand-clap for synchronizing the two videos and the audio. The clap must be done with the hands held over the Top Rectangle so it is visible to both cameras. Then the Lesson proceeds. When the Lesson is finished, both cameras and the Audio Recorder are stopped.

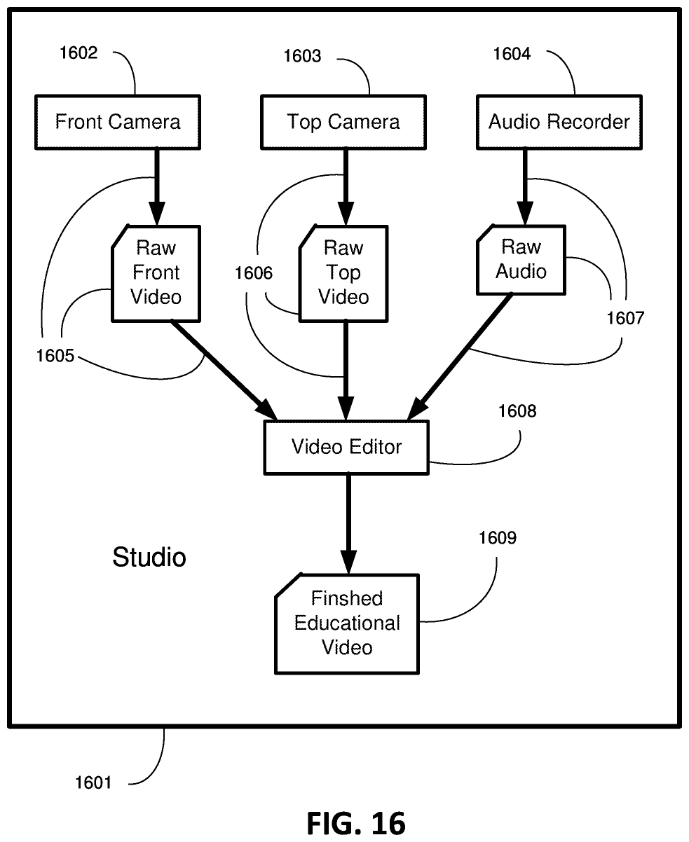

FIG. 16 functionally depicts the Studio, 1601, in terms of data flows. After the Lesson has been recorded, the raw video recorded by the Front Camera, 1602, is transferred, 1605, to the Video Editor, 1608; the raw video recorded by the Top Camera, 1603, is transferred, 1606, to the Video Editor; and the raw audio recorded by the Audio Recorder, 1604, is transferred, 1607, to the Video Editor. The Video Editor is then used to create the finished video of the Educational Video, 1609, of the Holistic Presentation.

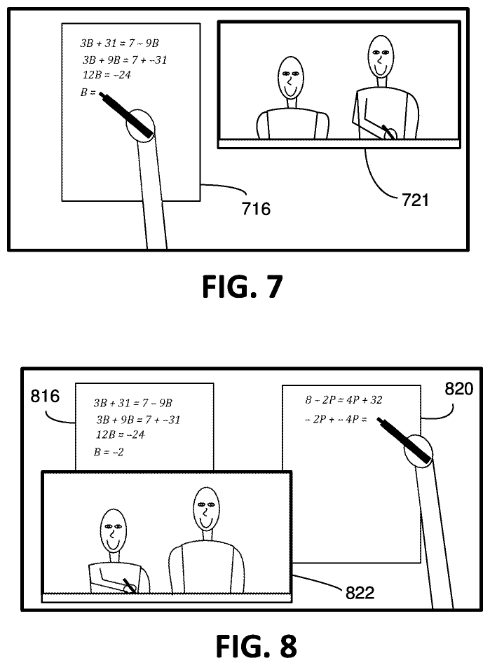

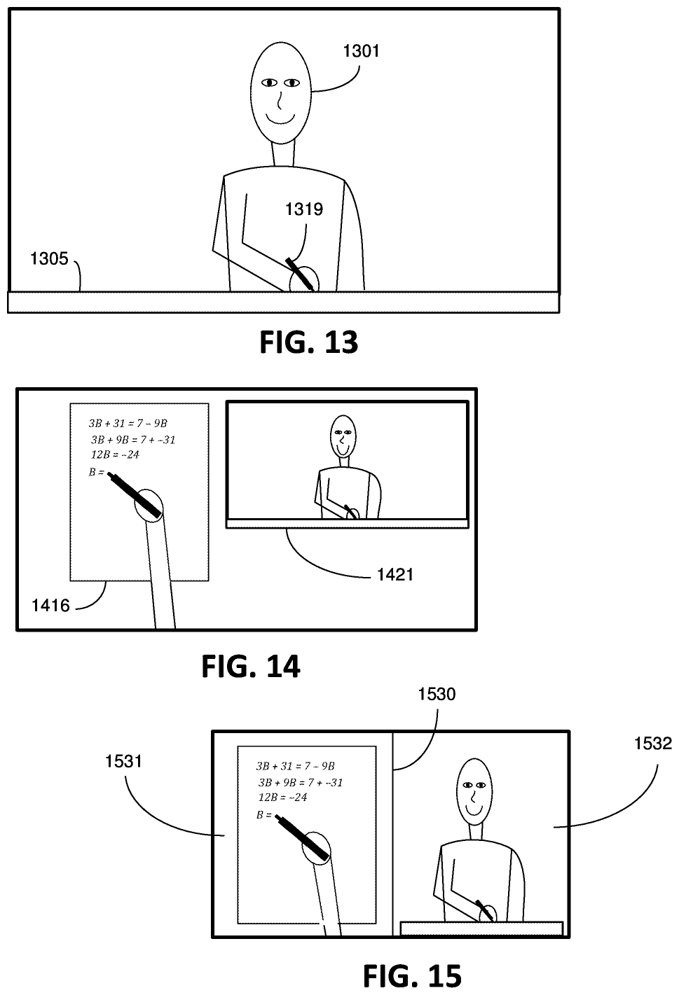

The Educational Video integrates the images from the two cameras. At a few times during the Educational Video, the image from just the Front Camera is shown, as in FIG. 13 (or, in the Second Embodiment, FIG. 5)—this might be done when the teacher is speaking without reference to any writing, and the image from the Top Camera might distract the Online Students. At other times, just the image from the Top Camera is shown, as in FIG. 6—this might be done for a complicated diagram (not shown in the Figs.) that occupies the entire image from the Top Camera. But most of the time, the image of the Front Camera is inset within the image of the Top Camera that otherwise occupies the entire screen area, as shown in FIG. 14 (or, in the Second Embodiment, FIGS. 7 and 8). That way, Online Students can clearly see what is being written, but they can simultaneously see in the inset the body language of the Teacher (and, in the Second Embodiment, the Studio Student). However, the inset will always cover a part of the area where papers may lie, so, depending on what is happening on the paper(s), the positioning and/or size of the inset will change at different times during the Educational Video.

For example, in either embodiment but as illustrated for the Second Embodiment, at a particular part of the video shown in FIG. 7, the Teacher is solving an equation on a paper, 716, on the left side of the screen that has been captured by the Top Camera, while an inset, 721, of the image from the Front Camera appears at the top right showing the faces and body language of the Teacher and Studio Student. Then, at a later point in the video shown in FIG. 8, the Studio Student is solving a similar equation on a paper, 820, on the right side of the screen, and the inset, 822, has been moved to the bottom left to get it out of the way, while also leaving visible the pertinent portion of the Teacher's paper, 816, at the top left. At other times in the video, the inset might get larger or smaller.

In another example, in either embodiment but as illustrated in the First Embodiment, at a particular part of the video shown in FIG. 15, the images from the two cameras are shown side-by-side, on either side of a dividing line, 1530—the Top Camera image in FIG. 6 has been cropped and placed on the left, 1531, and the Front Camera image in FIG. 13 has been cropped and placed on the right, 1532.

The final output from the Video Editor, 1608, is a fully rendered digital video file of the Educational Video, 1609, (typically an “.mp4” file) that beautifully captures the Holistic Presentation of the Lesson by the outstanding Teacher, which is then uploaded, 1726, to the Internet, 1727, and then downloaded, 1728, into various Players, 1725. An Online Student, 1829, then views the Educational Video on his or her Player, 1825, and watches the Teacher, 1801, teach the Lesson, including writing on paper, 1816. (Not shown in FIG. 18 is the image from the Top Camera in which the Studio Student can clearly read what the Teacher is writing.) The Studio Student experiences the Holistic Presentation by the outstanding Teacher and thereby learns the Lesson.

Normally, the Teacher or another person will operate the Video Editor and make “Editing Decisions” throughout the duration of the Lesson as to when, where and how to inset one video within the other; when and how to place cropped images from the two cameras side-by-side; when to show one camera's image in its entirety without the other camera's image; or other editing variations. However, the invention encompasses the possibility of the Video Editor taking certain parameters for making “intelligent” Editing Decisions automatically, thereby saving considerable time in the editing process. As a simple example, the parameters might direct the Video Editor: (a) to display, by default, the Top Camera image in the whole frame space, with the image from the Front Camera inset over that in the bottom right quadrant; (b) to detect hand motion in the image from the Top Camera, and when more than five seconds passes with no such hand motion, to switch to a full-frame display of the image to the Front Camera (omitting the Top Camera image), and (c) as soon as such hand motion is detected to switch back to the default display. Given the parameters, the Video Editor would then rapidly and automatically edit and output the rendered video. Upon viewing it, the Teacher or other person could then go in and make adjustments as needed, but the time savings could be significant.

Existing Players today—i.e., desktop computers, laptop computers, tablet computers and smart phones—are generally able to play video files, including in the “.mp4” digital format. An alternative configuration of the invention (not shown in the Figs.) is for the Video Editor to generate two separate but synchronized video channels—one entirely from the Front Camera, the other entirely from the Top Camera. In this configuration, the Online Student would either view both videos on a single Player that displays them simultaneously, or on a pair of separate but synchronized Players positioned near each other, and glance back and forth between the two videos.

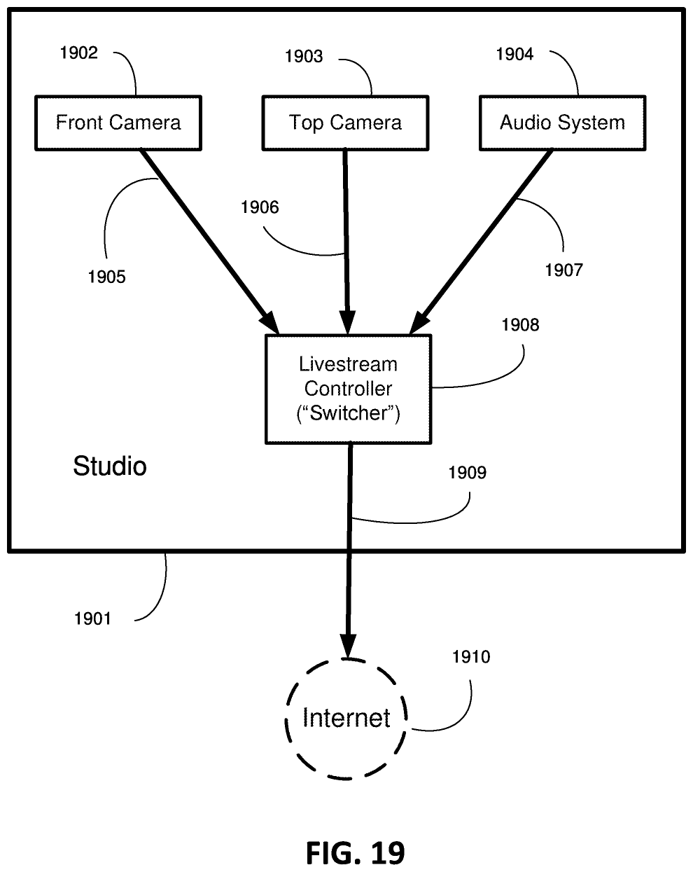

Yet another configuration is for the Holistic Presentation to be livestreamed to the Online Students. FIG. 19 functionally depicts the Studio, 1901, in terms of livestream signal flows. In this setup, the Audio Recorder is replaced with an Audio System, 1904, which might simply be the Mic or Mics, but will likely also include a pre-amplifier or signal processor into which the signal from the Mic (or Mics) is input, and which outputs a stronger audio signal, 1907. As the Teacher is teaching the Lesson, the Front Camera, 1902, emits its live video signal, 1905, to the Switcher, 1908; the Top Camera, 1903, emits its live video signal, 1906, to the Switcher; and the Audio System, 1904, emits its live audio signal, 1907, to the Switcher. The Switcher operates either automatically or under the live control of a director, to integrate the two video signals and the audio signal, and outputs the Holistic Presentation as a single livestream video signal, 1909, to the Internet, 1910, which is viewed in real time by the Online Students on their Players, 1725, 1825. Another variation is for the Switcher to output a pair of synchronized livestream videos to the Internet—one from the Front Camera; the other from the Top Camera, with the audio included in one or both—so that the Online Students can see both images simultaneously as discussed above for the pre-recorded configuration.

The Video Editor (in the pre-recorded configuration) and the Switcher (in the livestream configuration) are both “Video Integrators” that perform the function of integrating the video captured by the two cameras (as well as integrating in the audio) on the basis of Editing Decisions. The distinction is that the Video Editor does the integration “offline” so that time can be taken to make careful Editing Decisions, revise those decisions, and have others review the finished video before it is uploaded to the internet. In contract, the Switcher requires that the Editing Decisions be made in real time, and the integrated results of those decision are immediately seen by the Online Students—there is no opportunity to revise or improve Editing Decisions. Yet another possibility is for a Lesson to be livestreamed (via a Switcher) and recorded, with the recorded version later input into a Video Editor and integrated with better Editing Decisions, and then uploaded to the Internet.

The invention is anticipated to make it possible for the best teachers in the world to teach millions of students globally, bringing great benefit to humanity.

Therefore, the following is claimed:

1. A studio arrangement and a plurality of playing devices, the studio arrangement hereinafter being identified as the studio, the studio being used to produce an educational video of a person teaching a lesson, the person teaching the lesson hereinafter being identified as the teacher, the educational video including audio of the teacher's voice, the playing devices being physically located in different places than the studio, a playing device hereinafter being identified as a player, the educational video being transmitted digitally from the studio to each player, a player comprising a means for playing the educational video for a person to view, a plurality of persons each receiving the lesson by viewing the educational video on a player, the plurality of persons receiving the lesson hereinafter being identified as online students, the studio comprising:
a horizontal surface elevated above the floor, which surface is hereinafter identified as the table, the table having a front side and a back side;
a vertical backdrop positioned in the area behind the back side of the table;
the teacher sitting or standing between the backdrop and the back side of the table and facing the front side of the table;
a flat writing medium that lies on the table, the teacher writing on the writing medium during the lesson;
lights that illuminate the teacher, the writing medium and the backdrop;
a first video camera, which camera is hereinafter identified as the front camera, the front camera being positioned in the area beyond the front side of the table and pointing to the back side of the table, the front camera capturing images of the teacher's face, hands and upper body, and, behind the teacher, the backdrop, the front camera capturing video of the lesson;
a second video camera, which camera is hereinafter identified as the top camera, the top camera being positioned above the table, the top camera pointing downward at the table and capturing images of the writing medium, any writings thereon, and the teacher's hands as he or she writes thereon, the top camera capturing video of the lesson;
a means to synchronize the video from the front camera with the video from the top camera;
a means for the teacher to write on the writing medium that produces a solid, uniform marking of sufficient thickness that the teacher's writing is clearly captured by the top camera and is thereby clearly readable by the online students; and
a means to integrate the video from the front camera with the video from the top camera to produce the educational video, the integration means hereinafter being identified as the video integrator;
whereby, an online student viewing the educational video can clearly see the teacher's face, hands and upper body, and also clearly read what the teacher writes on the writing medium.

2. The studio arrangement and plurality of playing devices of claim 1 wherein the educational video is recorded and then transmitted, as a completed video, to the players, the online students then being able to view it at any subsequent time.

3. The studio arrangement and plurality of playing devices of claim 1 wherein the educational video is transmitted to the players in livestream format, as the teacher is teaching the lesson, the online students viewing the lesson at the same time that the teacher is teaching it.

4. The studio arrangement and plurality of playing devices of claim 1 wherein the video integrator outputs the educational video as a single video in which the videos from the front camera and top camera are synchronously integrated in a manner that includes, at some time in the educational video, either the insetting of the image from one of the cameras within the image of the other camera, or the placing of cropped portions of the two images side-by-side or one above the other.

5. The studio arrangement and plurality of playing devices of claim 4 wherein the video integrator makes decisions about the integration of the images from the two cameras automatically.

6. The studio arrangement and plurality of playing devices of claim 1 wherein the video integrator outputs the educational video as a pair of synchronized videos, one of which is taken exclusively by the front camera and the other of which is taken exclusively by the top camera, the plurality of playing devices including either:
a player that displays and plays the two videos simultaneously and in synchrony; or
two players that are physically close enough to one another that an online student can look back and forth between them as they play, one playing the first video, the other playing the second video, and the two players synchronizing the two videos as they play.

7. The studio arrangement and plurality of playing devices of claim 1 wherein the writing medium is paper, the means for the teacher to write thereon is a pen that produces a solid, uniform line on the paper that is about 1.5 millimeters thick, and the teacher writes therewith in a writing size that is proportionate with the line thickness and hence, in the educational video, can be clearly read by the online students.

8. The studio arrangement and plurality of playing devices of claim 7 additionally comprising a plurality of separate papers that the teacher uses in the lesson, one or more of the papers containing text that is printed thereon before the lesson is recorded, the font size of the text being at least 18 points.

9. The studio arrangement and plurality of playing devices of claim 7 additionally comprising a plurality of separate papers that the teacher uses in the lesson, one or more of the papers containing a diagram that is printed thereon before the lesson is recorded, the line thickness and details of the diagram being large enough that, in the educational video, the diagram can be clearly read by the online students.

10. The studio arrangement and plurality of playing devices of claim 7 additionally comprising a plurality of pens or highlighters that write in different ink colors, and with which the teacher writes during the lesson, each ink color serving an educational purpose in the lesson.

11. The studio arrangement and plurality of playing devices of claim 7 wherein a paper is ruled with parallel lines on which the teacher writes during the lesson, the lines being spaced wide enough that the teacher can write between them in a large enough hand that the writing can be clearly read by the online students.

12. The studio arrangement and plurality of playing devices of claim 7 wherein a paper is ruled in a grid of squares and on which the teacher draws graphs during the lesson, the grid lines being spaced wide enough that the details of the graphs drawn thereon by the teacher can be clearly seen by the online students.

13. The studio arrangement and plurality of playing devices of claim 1 wherein the studio additionally comprises:
an audio system that is separate from the front camera and separate from the top camera, the audio system including a microphone that is located near the teacher, the audio system capturing good quality audio of the teacher's voice during lesson,
a means to synchronize the audio from the audio system with the video from the front camera and the video from the top camera;
a means within the video integrator to integrate the audio from the audio system into the educational video.

14. The studio arrangement and plurality of playing devices of claim 1 in which one set of lines are marked upon the table to show the teacher the limits on the table of the image of the top camera, and another set of lines are marked on the table to show the teacher the limits on the table of the image of the front camera.

15. The studio arrangement and plurality of playing devices of claim 1 wherein another person, who is hereinafter identified as the studio student, sits or stands next to the teacher at the table in the studio, the teacher teaches the lesson to the studio student, the studio student writes on the writing medium during the lesson, the front camera images include the studio student's face, hands and upper body, the top camera images include the studio student's hands as he or she writes on the writing medium, and the online students receive the lesson not only from viewing the teacher teaching, but also from viewing the studio student learning.

16. The studio arrangement and plurality of playing devices of claim 15 wherein:
the studio additionally comprises an audio system that is separate from the front camera and separate from the top camera, the audio system including a pair of microphones that are located near the teacher and the studio student, respectively, the audio system capturing two channels of good quality audio of the teacher's and studio student's respective voices during lesson;
a means to synchronize the two-channel audio from the audio system with the video from the front camera and the video from the top camera;
the writing medium is a plurality of papers, the means for the teacher and studio student to write thereon comprises a first pen that produces a solid, black uniform line on the paper that is about 1.5 millimeters thick, the teacher and studio student writing at separate times therewith in a large enough hand that the writing can be clearly read by the online students, and a second pen or a highlighter of a color other than black, its color serving an educational purpose in the lesson;
one or more of the papers contain text that is printed thereon before the lesson and are used by the teacher during the lesson, the font size of the text being large enough that, in the educational video, the text can be clearly read by the online students;
one or more of the papers are ruled with parallel lines for writing upon, the teacher or the studio student writing thereon during the lesson, the lines being spaced wide enough that the teacher or studio student can write between them in a large enough hand that the writing can be clearly read by the online students;
the video integrator includes a means to synchronously integrate the two-channel audio into the educational video;
the video integrator outputs the educational video as a single video in which the videos from the front camera and top camera are synchronously integrated in a manner that includes, at some time in the educational video, either the insetting of the image from one of the cameras within the image of the other camera, or the placing of cropped portions of the two images side-by-side or one above the other.

17. A method comprising:
positioning a person, who is hereinafter identified as the teacher, in a studio arrangement, which is hereinafter identified as the studio, the teacher being prepared to teach a lesson, the studio comprising a horizontal surface elevated above the floor, which surface is hereinafter identified as the table, the table having a front side and a back side, and a vertical backdrop in the area behind the back side of the table, the teacher sitting or standing between the backdrop and the back side of the table and facing the front side of the table, the studio further comprising a flat writing medium that lies on the table, lights to illuminate the teacher, the writing medium and the backdrop, a first video camera, which camera is hereinafter identified as the front camera, the front camera being positioned in the area beyond the front side of the table and pointing to the back side of the table, and a second video camera, which camera is hereinafter identified as the top camera, the top camera being positioned above the table and pointing downward at the table;
adjusting the image of the front camera so that, when the camera is activated, it will capture images of the teacher's face, hands and upper body as he or she teaches the lesson, and, behind the teacher, the backdrop;
adjusting the image of the top camera so that, when the camera is activated, it will capture images of the writing medium and the teacher's hands as he or she writes thereon during the lesson;
activating the lights;
activating the front camera so that it captures video of the lesson;
activating the top camera so that it captures video of the lesson;
synchronizing the videos from the front camera and top camera;
the teacher teaching the lesson, and while teaching, writing on the writing medium with a writing device that produces a solid, uniform marking of sufficient thickness that the teacher's writing is clearly captured by the top camera;
integrating the videos from the front camera and the top camera to produce an educational video which clearly shows the teacher's face, hands and upper body, and also clearly shows what the teacher writes on the writing medium, the educational video including audio of the teacher's voice;
transmitting the educational video digitally to a plurality of playing devices, a playing device hereinafter being identified as a player, each player being physically located in a different place than the studio, each player being capable of playing the educational video for a viewer;
a plurality of persons each learning the lesson by viewing the educational video on a player.

18. The method of claim 17 comprising the further step of integrating the videos, at some time during the lesson, either by insetting the image from one of the cameras within the image of the other camera, or placing cropped portions of the two images side-by-side.

19. The method of claim 17 wherein the studio additionally comprises an audio system to obtain good quality audio of the teacher's voice, the audio system being separate from the front camera and separate from the top camera, the audio system including a microphone, the method comprising the further steps of:
positioning the microphone near the teacher;
activating the audio system in conjunction with activating the front camera and top camera, so that it captures audio of the lesson;
synchronizing the audio from the audio system with the videos from the front camera and top camera;
integrating the audio from the audio system into the educational video.

20. The method of claim 17 comprising the further steps of:
positioning another person in the studio, who is hereinafter identified as the studio student, next to the teacher;
adjusting the image of the front camera so that, when activated, it will additionally capture the studio student's face, hands and upper body;
adjusting the image of the top camera so that, when activated, it will additionally capture the studio student's hands as he or she writes on the writing medium;
the teacher teaching the lesson to the studio student, and during the lesson, the studio student writing on the writing medium;
the plurality of persons receiving the lesson not only by viewing the teacher teaching, but also by viewing the studio student learning.
